(19) United States
(12) Patent Application Publication
(10) Pub. No.: US 2022/0171530 A1
(43) Pub. Date: Jun. 2, 2022

(54) DISPLAYING A USER INPUT MODALITY

(71) Applicant: Lenovo (Singapore) Pte. Ltd., Singapore (SG)

(72) Inventors: Russell Speight VanBlon, Raleigh, NC (US); Arnold Weksler, Raleigh, NC (US); Nathan Peterson, Durham, NC (US); John C. Mese, Cary, NC (US); Rod D. Waltermann, Rougemont, NC (US); Jason Pratt Parrish, Durham, NC (US)

(21) Appl. No.: 17/675,421

(22) Filed: Feb. 18, 2022

Related U.S. Application Data
(63) Continuation-in-part of application No. 14/631,205, filed on Feb. 25, 2015.
Application No. 14/631,205 is a continuation-in-part of application No. 14/301,556, filed on Jun. 11, 2014.

(51) Int. Cl. G06F 3/04886; G06F 3/0346; G06F 3/01

(52) U.S. Cl. CPC G06F 3/04886; G06F 3/013; G06F 3/0346

(57) ABSTRACT

An aspect provides a method, including: determining, using at least one detector, a location of a hand of a user with respect to an information handling device; receiving, from at least one sensor, gaze tracking data associated with an eye of a user; determining, using a processor and based upon the gaze tracking data, a location within an application currently active on the information handling device of a gaze of the user; identifying, using a processor, a character type associated with the application and corresponding to the determined location; identifying a keyboard having a keyboard layout corresponding to the character type, wherein the identifying a keyboard includes identifying a keyboard layout allowing provision of the identified character type; and displaying, on a display device of the information handling device, at a location corresponding to the location of the hand of the user, the keyboard having the keyboard layout.

### CROSS-REFERENCE TO RELATED APPLICATIONS

This application is a continuation-in-part of U.S. patent application Ser. No. 14/631,205, entitled “DISPLAYING A USER INPUT MODALITY,” filed on Feb. 25, 2015, which is a continuation-in-part of U.S. patent application Ser. No. 14/301,556, entitled “DISPLAYING A USER INPUT MODALITY,” filed on Jun. 11, 2014, the contents of all of which are incorporated by reference herein.

### BACKGROUND

When inputting data into an information handling device (e.g., smart phone, tablet, etc.), the user generally uses a touch keyboard located at a particular location on the display screen of the information handling device. The keyboard layout may change automatically based upon the orientation (e.g., landscape, portrait, etc.) of the information handling device. Generally, the user is also able to manually change the layout of the keyboard.

In addition, some applications (e.g., document generation programs, web browsers, and the like) have a particular type of keyboard that is associated with the application. For example, a web browser may have a SWYPE keyboard that is displayed when the user opens the web browser. In some situations, the user may also be able to manually change the type of keyboard that is displayed (e.g., one-handed keyboard, two-handed keyboard, SWYPE keyboard, SWIFTKEY keyboard, etc.). SWYPE is a registered trademark of SWYPE, Inc. in the United States and other countries. SWIFTKEY is a registered trademark of TouchType Limited in the United Kingdom and other countries.

### BRIEF SUMMARY

In summary, one aspect provides a method, including: determining, using at least one detector, a location of a hand of a user with respect to an information handling device; receiving, from at least one sensor, gaze tracking data associated with an eye of a user; determining, using a processor and based upon the gaze tracking data, a location within an application currently active on the information handling device of a gaze of the user; identifying, using a processor, a character type associated with the application and corresponding to the determined location; identifying a keyboard having a keyboard layout corresponding to the character type, wherein the identifying a keyboard includes identifying a keyboard layout allowing provision of the identified character type; and displaying, on a display device of the information handling device, at a location corresponding to the location of the hand of the user, the keyboard having the keyboard layout.

Another aspect provides an information handling device, including: at least one detector; at least one sensor; a display; at least one processor operatively coupled to the display, the at least one sensor, and the at least one detector; and a memory device that stores instructions that, when executed by the processor, cause the information handling device to: determine, using the at least one detector, a location of a hand of a user with respect to an information handling device; receive, from the at least one sensor, gaze tracking data associated with an eye of a user; determine, using the processor and based upon the gaze tracking data, a location within an application currently active on the information handling device of a gaze of the user; identify, using the processor, a character type associated with the application and corresponding to the determined location; identify a keyboard having a keyboard layout corresponding to the character type, wherein the identifying a keyboard includes identifying a keyboard layout allowing provision of the identified character type; and display, on the display device, at a location corresponding to the location of the hand of the user, the keyboard having the keyboard layout.

A further aspect provides a product, including: a computer-readable storage device that stores executable code that, when executed by a processor, causes the product to: determine, using at least one detector, a location of a hand of a user with respect to an information handling device; receive, from at least one sensor, gaze tracking data associated with an eye of a user; determine, using a processor and based upon the gaze tracking data, a location within an application currently active on the information handling device of a gaze of the user; identify, using a processor, a character type associated with the application and corresponding to the determined location; identify a keyboard having a keyboard layout corresponding to the character type, wherein the identifying a keyboard includes identifying a keyboard layout allowing provision of the identified character type; and display, on a display device of the information handling device, at a location corresponding to the location of the hand of the user, the keyboard having the keyboard layout.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of displaying a user position based input modality.

FIG. 4 illustrates an example method of display a gaze based input modality.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Information handling devices with touch capabilities (e.g., smart phones, tablets, book readers, etc.) generally provide a touch sensitive keyboard located at a particular location on the touch screen. In addition to these touch keyboards there are projected keyboards in which a keyboard is projected onto a surface separate from the information handling device. These common methods of keyboard display generally have a specific keyboard layout that is displayed. A user may have the ability to change the layout of the keyboard based upon the user's preference, but this has to be completed manually by the user.

In the case of an information handling device with a touch keyboard, the position of the keyboard may change automatically when the orientation (e.g., landscape, portrait, etc.) of the device is changed. For example, if the user is holding the device they may rotate the device and the keyboard may change positions on the display, so that the keyboard remains in the same general location on the display (e.g., the keyboard is displayed at the bottom of the display despite the orientation of the device). However, if the user is holding the device and using the keyboard with one hand and then lays the device on a table to use the keyboard with two hands, the keyboard layout does not change. For example, if the user is using the one-handed keyboard layout while holding the device, the keyboard does not automatically change to a two-handed keyboard when the device is laid down.

In some situations, an application (e.g., web browser, text messaging application, document generator, etc.) may have a preferred keyboard layout associated with it. For example, a document generator application may have a two-handed keyboard layout as the preferred keyboard layout. On the other hand, a web browser may have a SWYPE keyboard layout as the preferred keyboard layout. However, these keyboard layouts are driven by the application and are not based upon how the user is using the device. Additionally, the keyboard layouts are not driven by the content the user is trying to enter. For example, if a user is trying to enter numeric characters, the user has to manually select a numeric keypad.

Accordingly, an embodiment provides a method for automatically detecting the user's position relative to the information handling device and displaying a keyboard layout based upon how the user is using the device. For example, if the user is holding the device in his or her left hand, then a one-handed keyboard layout associated with use by a right hand may be displayed automatically. Likewise, if the user is holding the device in his or her right hand, then a one-handed keyboard layout associated with use by the left hand may be displayed automatically. Alternatively, if the device is placed on a flat surface then a two-handed keyboard layout may be displayed automatically.

Additionally or alternatively, an example embodiment may determine an application that is currently active on the information handling device and use this information to assist in determining the input modality to be displayed. For example, if a user is holding a device in his or her right hand and the device is running a text messaging application, an embodiment may display a SWYPE keyboard layout (or like keyboard, collectively referred to as a “swipe” keyboard) to be used with the left hand. Alternatively, if a user is holding a device in his or her right hand and is running a document generator, an embodiment may display a numeric keyboard layout.

Another example embodiment may determine the location of at least one hand of the user and provide a keyboard layout at the location on the display associated with the location of the at least one hand. For example, if the user has a hand positioned in the middle of the display, then an embodiment may provide a keyboard layout in the middle of the display rather than at the default location (e.g., at the bottom of the display).

A further example embodiment may allow the user to select the type of keyboard layout that should be associated with the position of the user with respect to the information handling device. An embodiment may then remember this selection and display the selected keyboard layout whenever the user is using the device in the same way. For example, a user may select to use a SWIFTKEY keyboard when the device is being held in his or her left hand. An embodiment may remember this selection and always display a SWIFTKEY keyboard when a user is holding the device in his or her left hand.

One example embodiment, which may be combined with other embodiments, provides a method for automatically detecting the location of the user's gaze on the information handling device and displaying a keyboard layout based upon the content associated with the location of the user's gaze. For example, if a user is looking at a text field on a form, a keyboard allowing text entry may be displayed. Likewise, if a user is looking at a numeric field, a keyboard allowing numeric entry may be displayed. Additionally, an embodiment may provide suggested content to be filled into the content area. Alternatively, one embodiment may determine that a user is looking at a location in which the content does not allowing for character entry and may hide the keyboard. An alternative or additional embodiment may determine that the content the user is looking at comprises a large area of the display and may reduce the size of the keyboard to minimize the amount of content that is covered by the keyboard.

The illustrated example embodiments will be best understood by reference to the figures. The following description is intended only by way of example, and simply illustrates certain example embodiments.

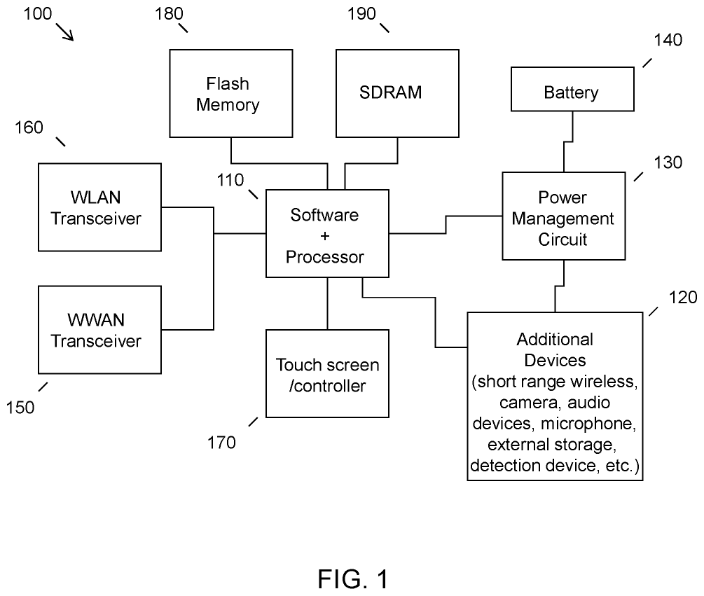

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120), which may include detectors (e.g., accelerometers, gyroscopes, cameras, etc.), may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additional devices 120 are commonly included, e.g., accelerometers, gyroscopes, cameras, etc. System 100 often includes a touch screen 170 for data input and display/rendering (e.g., displaying a keyboard layout for the user to input data). System 100 also typically includes various memory devices, for example flash memory 180 and SDRAM 190.

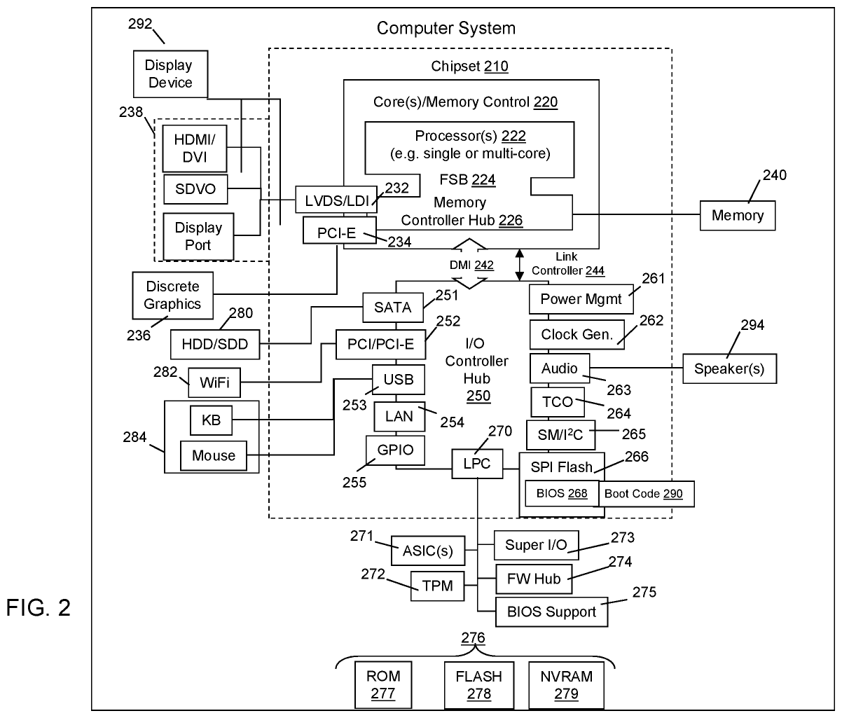

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries.

The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a CRT, a flat panel, a touch screen that may also display a keyboard layout for data input, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Circuitry, as for example outlined in FIG. 1 or FIG. 2, may be used in information handling devices that may have touch screen capabilities. Alternatively or additionally, circuitry such as that outlined in FIG. 1 or FIG. 2 may be included in devices that have the capability of supporting projection keyboards. The information handling devices that may use the circuitry outlined in FIG. 1 or FIG. 2, may also have detectors included within the device or operatively coupled to the device.

It should be noted that the embodiments described herein are not mutually exclusive. In other words, one embodiment can be combined with another embodiment even if discussed as two separate embodiments. Thus, the description is not intended to limit each embodiment discussed to a single and unique embodiment as many of the embodiments can be combined together in the same framework and not deviate from the scope of this disclosure.

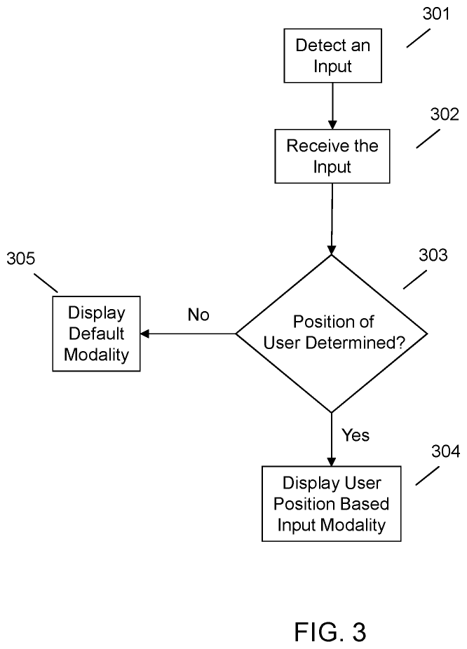

Referring to FIG. 3, an embodiment may use a detector (e.g., a camera, a touch sensor, a proximity sensor, an accelerometer, a gyroscope, a combination of such devices, etc.) to detect an input associated with the position of a user with respect to an information handling device (e.g., a smart phone, a tablet, a laptop, a book reader, etc.). This detection may allow an embodiment to detect that a user is near the information handling device. For example, an embodiment may use a camera or touch sensors located on a smart phone to detect that a user is near the smart phone. The device may also employ proximity sensors or other sensors located on the device to detect that a user is touching the device and at what location on the device that the user is touching the device. At 302, the processor of an embodiment may receive the input associated with the position of the user with respect to the information handling device, detected by the detector at 301.

An embodiment may determine, at 303, the position of the user with respect to the information handling device and/or with respect to a display, input modality (e.g., mechanical keyboard, projection keyboard, mouse, soft keyboard, etc.), or other component of the information handling device. For example, an embodiment may use a gyroscope and camera included in a tablet to determine that the user is holding the tablet in his or her left hand. As another example, an embodiment may use a proximity sensor to determine that the user is close to, but not touching the device. The system may further determine a particular location on the device that the user is near, touching, approaching, or the like. For example, the system may determine that the user is near the left side, bottom side, lower right side, near an external component of the device/system, or the like. Determining the particular location may be used by the system to determine the location and/or type of input modality to display on or for the device.

Thus, an embodiment may determine the position of the user at 303 by identifying the position of the information handling device. For example, an embodiment may use a gyroscope and accelerometer to determine that a tablet is being held by a user rather than laying flat on a surface. Additionally or alternatively, an embodiment may determine the position of the user at 303 by identifying the position of a user's at least one hand with respect to the information handling device. For example, an embodiment may use a camera to determine that the user has two hands positioned at the bottom of the tablet. Alternatively or additionally, an embodiment may use touch or proximity sensors to determine the position of the user with respect to the information handling device.

In an embodiment, if the position of the user is unable to be determined at 303, then a default keyboard layout or modality may be displayed at 305. The default keyboard layout or modality may also include a default location on the display or external location to display the default keyboard layout or modality. A default keyboard layout may be, for example, a one-handed keyboard displayed at the bottom of the display of the information handling device. If, however, the position of the user is able to be determined at 303, then a user position based input modality (e.g., a right-handed keyboard, a left-handed keyboard, a two-handed keyboard, a SWYPE keyboard, a track pad, a numeric keypad, etc.) based on the position of the user with respect to the information handling device may be displayed at 304. In other words, the system may display an input modality or keyboard layout that corresponds to how the user is holding, touching, or approaching the device and may also display that input modality or keyboard layout in a location on the display or external location that corresponds to how the user is holding, touching, or approaching the device. For example, a smart phone may determine that the user is holding the device in their right hand and may display a left-handed keyboard to be used by the user. Alternatively, a tablet may determine that the user has one finger positioned over the device and may display a track pad to be used by the user.

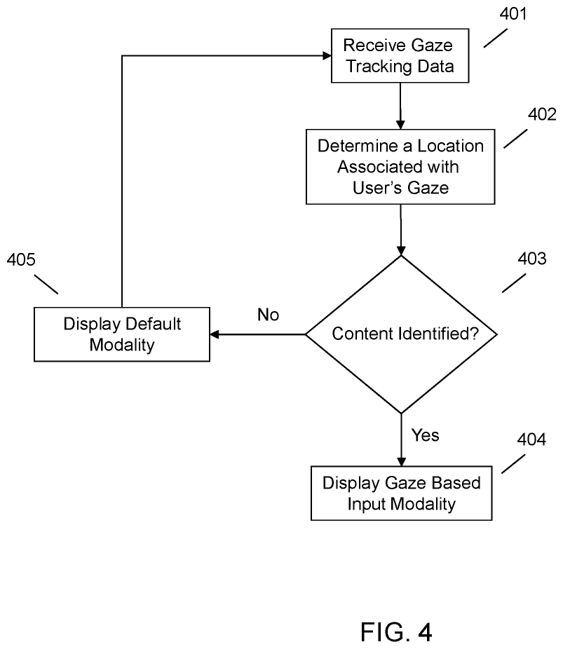

Additionally, an embodiment may display a user input modality at the position on the display associated with the position of the user's at least one hand. For example, if a user's hand is positioned at the top of the display then a keyboard layout may be displayed at the top of the display rather than at the default location (e.g., the bottom of the display). This may, for example, allow a user to input data anywhere on the display. Additionally, allowing this flexibility may prevent data from being covered by the keyboard layout if there is data located at the location where the keyboard is normally displayed on the display. Thus, an embodiment may additionally take into account other factors in determining either the location and/or the modality type when displaying the input modality. For example, if an embodiment determines that displaying an input modality at the location the user position indicates would cover content, an embodiment may move the determined location to be at a slightly different location, but in the same area as where the user position would indicate, so as to not cover the content that the user where the user would be providing input. Determining a location where the user would be providing input may be determined in conjunction with the gaze tracking and gaze location identification discussed in further detail with respect to FIG. 4.

An embodiment may determine what keyboard layout to display at 304 by determining the application that currently active on the information handling device. An embodiment may use this information in conjunction with the user position with respect to the information handling device to determine the best keyboard layout to be displayed. For example, if a user is currently using a calculator application and has one hand positioned on or over the tablet, an embodiment may display a numeric keypad layout. Alternatively, if a user is currently using a text messaging application and has one hand positioned on or over the tablet, an embodiment may display a SWYPE keyboard layout. The active application may also be utilized in determining a location to display the input modality. For example, the active application may provide insight into content that should not be covered by the input modality. As an example, if the active application has static content and dynamic content and is a dynamic content sharing application, the system may determine that the input modality should not cover the dynamic content of the application.

An embodiment may display a user interface allowing the user to manually select the user input modality and/or input modality location to be associated with the position of the user, the active application, the gaze of the user, a field type, or the like. For example, a user may prefer that when the tablet is laying flat on a surface that a left-handed keyboard be displayed rather than a two-handed keyboard. As another example, a user may prefer a particular input modality and/or modality location when a certain application or type of application is active. As another example, a user may prefer a particular input modality type and/or modality location when a particular field type is active. In an embodiment, a user may select this keyboard layout using a user interface. Additionally, an embodiment may remember the user's selection and may automatically display this type of keyboard layout and/or input modality location when the user and/or information handling device are in the same or similar positions. Using one of the examples above, an embodiment may always display a left-handed keyboard when the tablet is laying flat on a surface rather than displaying a two-handed keyboard.

This disclosure will now turn to FIG. 4. However, it should be noted that while the embodiments described in FIG. 3 and FIG. 4 are shown as separate embodiments, this is not intended to limit these to separate embodiments. In other words, the techniques described in connection with FIG. 3 can be applied to the techniques described in connection with FIG. 4 and vice versa. Stated differently, and as an example, the gaze tracking techniques used for determining the type and location of a keyboard or other input modality as described in connection with FIG. 4 can be incorporated into the user position techniques used for determining the type and location of a keyboard or other input modality as described in connection with FIG. 3, and vice versa.

Referring now to FIG. 4, an embodiment may receive gaze tracking data associated with a user's eye at 401. This gaze tracking data may be received from a sensor, for example, a camera that captures visual images, an image capture device that captures non-visible light, an eye tracker, an optical sensor, and the like. The sensor may be connected or coupled to an information handling device, either wirelessly or through a wired connection. Alternatively or additionally, the sensor(s) may be integral to the information handling device. Once the gaze tracking data is received, an embodiment, at 402, may determine a location on an information handling device associated with the user's gaze based upon the gaze tracking data. For example, an embodiment may determine the exact location, for example, pixel location, coordinate location, application field location, and/or the like, on the information handling device where the user is looking by passing the image or other gaze tracking data to a gaze tracking system or application running on the device for resolution.

An embodiment may then, at 403, identify content associated with the determined location. For example, an embodiment may identify the field type of content in a display that is associated with the location of the user's gaze. Determining the field type may, for example, include identifying or determining the field formatting which may indicate the type of characters to be entered, for example, numeric characters, alphanumeric characters, letters, symbols, graphics and the like. Alternatively or additionally, the field type may include the field descriptor, for example, a “To:” field, “Phone Number” field, “Comment” field, and the like. As another example, an embodiment may determine the character type associated with the location that the user is looking. For example, an embodiment may determine that the user is looking at a location in which alpha characters have already been entered.

Alternatively or additionally, an embodiment may identify other types of content, for example, the underlying application or portion thereof, active window or tab in a display, field size, whether the location where the user is looking does not allow or require character input (e.g., a field that is not editable, a radial button selection, a menu selection, etc.), and the like. In one embodiment, upon identifying the content associated with the location, one embodiment may make this content active. For example, an embodiment may make the field that the user is looking at an active field allowing character input. As another example, an embodiment may select the location associated with the user's gaze.

If an embodiment cannot identify the content associated with the determined location, it may display a default input modality at 405. Additionally or alternatively, an embodiment may wait to receive additional gaze tracking data or other data. If, however, an embodiment can identify the content associated with the location, an embodiment may, at 404, display a user gaze-based input modality based upon the identified content. For example, if an embodiment identifies the content using the field type, an embodiment may determine that the user is looking at a field in a form which requires the user to enter a numeric value. Based upon this identification, an embodiment may display a numeric keypad allowing the user to enter numbers into the field without the user having to manually select the numeric keypad. As another example, an embodiment may determine that the user is looking at a “To:” field in an email application and may then display a keyboard including symbols. As an additional example, if a user is accessing a word processing document and accesses a menu option which presents a pop-up display, an embodiment may determine that the field entry where the user is looking requires an alpha character entry. An embodiment may then display an input device including alpha characters.

As an alternative or additional example, an embodiment may identify the character type associated with the location that the user is looking and may then display an input modality corresponding to the character type which is at that location. As an example, if a user is accessing a spreadsheet and the location where the user is looking has numeric characters already input, an embodiment may display a numeric keypad allowing the user to enter additional numeric characters. If an embodiment uses the underlying application to identify the content, an embodiment may display an input modality based upon the location of the user's gaze and the identified application. For example, an embodiment may determine that a user is looking at a particular location, for example, the message field in a text messaging application. An embodiment may then display an input modality which includes emoticons or other text messaging appropriate input modality.

In addition to displaying an input modality based upon the location of the user's gaze, an embodiment may display a cursor at the location of the user's gaze. This cursor display may include, for example, moving the cursor from one location to the current location of the user's gaze or may include placing a new cursor at the specified location. Additionally or alternatively, an embodiment may display suggested content associated with the location of the user's gaze. For example, if a user is accessing an email application, an embodiment may determine that the user is looking at a “username” field and may provide suggestions of content which may be entered into this field. These suggestions may include previously entered user selections. Alternatively or additionally, a user may enter a character or plurality of characters and an embodiment may make suggestions based upon this entry of data.

In conjunction with or in lieu of the placement of the keyboard, as discussed above, an embodiment may reduce the size of the input modality if an embodiment determines that the entry field would be hidden or obscured by the size of the input modality. Additionally, if an embodiment identifies the content associated with the location of the user's gaze does not allow or require character input, the input modality may be hidden completely.

An embodiment may display a user interface allowing the user to manually select the user input modality to be displayed. For example, a user may want to enter symbols but the keyboard displayed only allows numeric character entry. An embodiment may then allow the user to manually select the input device to be displayed. Alternatively or additionally, a user may prefer that a particular keyboard layout, for example, a left-handed keyboard, a right-handed keyboard, a numeric keypad, and the like, is displayed when entering data into a form and may manually select the preferred keyboard. This manual selection of input device or keyboard layout may be accomplished using a user interface. Additionally, an embodiment may remember the user's selection and may automatically display this type of keyboard layout.

Therefore, an embodiment may automatically provide a keyboard layout based on the user's position with respect to the information handling device. An embodiment may determine the type of keyboard to display by using detector(s) to determine the position of the user and the device. Additionally, an embodiment may use the active application to help determine the type of keyboard layout to provide to the user. An embodiment may also learn the preferences of the user and use those preferences to determine the type of keyboard layout to provide to the user. Thereby reducing the burden on the user to select different keyboard layouts based upon how the user is using the device. Additionally, an embodiment may provide a keyboard layout in a different location on the display. Thus allowing a user to input data anywhere on the display rather than just at the default keyboard location.

Therefore, an embodiment may automatically provide a keyboard layout or input device based on the user's position with respect to the information handling device or based upon the content associated with the user's gaze. An embodiment may determine the type of input device to display by using detector(s)/sensor(s) to determine the position of the user and the device and/or the location of the user's gaze. Additionally, an embodiment may use the active application to help determine the type of keyboard layout or input device to provide to the user. An embodiment may also learn the preferences of the user and use those preferences to determine the type of input device to display to the user. Additionally, an embodiment may provide an input device in a different location on the display, reduce the size of the input device, or may alternatively hide the input device or change the input device based on the user's gaze. Thus an embodiment allows a user to input data anywhere on the display rather than just at the default keyboard location. An embodiment may additionally or alternatively provide an input device that is automatically selected based upon the content associated with the user's gaze.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
determining, using at least one detector, a location of a hand of a user with respect to an information handling device;
receiving, from at least one sensor, gaze tracking data associated with an eye of a user;
determining, using a processor and based upon the gaze tracking data, a location within an application currently active on the information handling device of a gaze of the user;
identifying, using a processor, a character type associated with the application and corresponding to the determined location;
identifying a keyboard having a keyboard layout corresponding to the character type, wherein the identifying a keyboard comprises identifying a keyboard layout allowing provision of the identified character type; and
displaying, on a display device of the information handling device, at a location corresponding to the location of the hand of the user, the keyboard having the keyboard layout.

2. The method of claim 1, wherein the displaying comprises displaying a keyboard layout comprising character input keys corresponding to the character type identified.

3. The method of claim 1, wherein the identifying comprises identifying a field type associated with the location of the gaze.

4. The method of claim 1, further comprising selecting the content associated with the gaze as active content.

5. The method of claim 1, wherein the determining a location of a hand of a user comprises determining an orientation of the information handling device.

6. The method of claim 1, wherein the content comprises a location that does not allow character input; and
wherein the displaying comprises hiding the keyboard.

7. The method of claim 1, wherein the displaying comprises one of reducing the size of the keyboard and adjusting the location of the keyboard such that the location associated with the gaze remains uncovered.

8. The method of claim 1, further comprising displaying suggested content associated with the location determined.

9. The method of claim 1, further comprising displaying a user interface allowing the user to manually select the keyboard layout and keyboard location.

10. The method of claim 1, wherein the displaying of the keyboard comprises changing an actively displayed keyboard based upon the gaze.

11. An information handling device, comprising:
at least one detector;
at least one sensor;
a display;
at least one processor operatively coupled to the display, the at least one sensor, and the at least one detector; and
a memory device that stores instructions that, when executed by the processor, cause the information handling device to:
determine, using the at least one detector, a location of a hand of a user with respect to an information handling device;
receive, from the at least one sensor, gaze tracking data associated with an eye of a user;
determine, using the processor and based upon the gaze tracking data, a location within an application currently active on the information handling device of a gaze of the user;
identify, using the processor, a character type associated with the application and corresponding to the determined location;
identify a keyboard having a keyboard layout corresponding to the character type, wherein the identifying a keyboard comprises identifying a keyboard layout allowing provision of the identified character type; and
display, on the display device, at a location corresponding to the location of the hand of the user, the keyboard having the keyboard layout.

12. The information handling device of claim 11, wherein the displaying comprises displaying a keyboard layout comprising character input keys corresponding to the character type identified.

13. The information handling device of claim 11, wherein the identifying comprises identifying a field type associated with the location of the gaze.

14. The information handling device of claim 11, further comprising selecting the content associated with the gaze as active content.

15. The information handling device of claim 11, wherein the determining a location of a hand of a user comprises determining an orientation of the information handling device.

16. The information handling device of claim 11, wherein the content comprises a location that does not allow character input; and
wherein the displaying comprises hiding the keyboard.

17. The information handling device of claim 11, wherein the displaying comprises one of reducing the size of the keyboard and adjusting the location of the keyboard such that the location associated with the gaze remains uncovered.

18. The information handling device of claim 11, further comprising displaying suggested content associated with the location determined.

19. The information handling device of claim 11, further comprising displaying a user interface allowing the user to manually select the keyboard layout and keyboard location.

20. A product, comprising:
a computer-readable storage device that stores executable code that, when executed by a processor, causes the product to:
determine, using at least one detector, a location of a hand of a user with respect to an information handling device;
receive, from at least one sensor, gaze tracking data associated with an eye of a user;
determine, using a processor and based upon the gaze tracking data, a location within an application currently active on the information handling device of a gaze of the user;
identify, using a processor, a character type associated with the application and corresponding to the determined location;
identify a keyboard having a keyboard layout corresponding to the character type, wherein the identifying a keyboard comprises identifying a keyboard layout allowing provision of the identified character type; and
display, on a display device of the information handling device, at a location corresponding to the location of the hand of the user, the keyboard having the keyboard layout.
